(19) United States
(12) Patent Application Publication
(10) Pub. No.: US 2002/0047650 A1
(43) Pub. Date: Apr. 25, 2002

(54) CIRCUIT AND METHOD TO REDUCE RASTER MOIRE

(76) Inventor: HIDEKI YUMOTO, CHULA VISTA, CA (US)

Correspondence Address: TERRANCE A MEADOR, GRAY CARY WARE AND FREIDENRICH, 401 B STREET SUITE 1700, SAN DIEGO, CA, 92101

(21) Appl. No.: 09/149,722

(22) Filed: Sep. 8, 1998

(51) Int. Cl. G09G 1/04

(52) U.S. Cl. 315/364

(57) ABSTRACT

A display raster cancellation system using a microprocessor and associated program is disclosed to control moiré pattern appearance on the display's screen. The program of microprocessor (126) controls a signal that is applied to a moiré circuit (130). Input to the microprocessor may be data obtain from the system's video input signal. A synch separator (120) may output horizontal pulses and vertical pulses obtained from the video signal. The following three functions may be performed on the video signal: interlace-progressive (I/P) discrimination (122), scan rate discrimination (124), and vertical resolution discrimination (125). The system may be used for standard television sets, digital television units, computer monitors or other raster display systems. The system may have the I/P, scan rate and vertical resolution input directly to the microprocessor (127) from an external video source via certain control signals.

### BACKGROUND OF THE INVENTION

The invention relates to adaptive control of moiré cancellation in a display device.

Raster scanning is a common technique to display images on television receivers, computer monitors, and other CRT (cathode ray tube) display devices. In this technique, electron beams emitted from electronic guns of the CRT are deflected by an electromagnetic field (or, in some cases, by an electrostatic field) starting at the top left comer of the CRT screen, and scanning from left to right along a trace called a scan-line, raster line, or simply a line. For the next line, the raster shifts slightly downward and again scans from left to right. This manner of scanning continues to the bottom right comer to fill the whole screen. One entire scan of the screen is called a frame. Following this, the scan repeats for another frame from the top left to the bottom right of the screen. This is called a progressive type of scanning. An alternate scanning method is a 2:1 interlace scanning, where each frame is made up of two fields. In this regard, all of the lines of the frame are consecutively numbered. To form a frame, a first field scans the odd numbered lines and a second field scans the even numbered lines, interleaved with the first field. Thus, 2:1 interlace scanning has two fields per frame. A progressive scan may have one field per frame or a plurality of fields per frame.

To display color images on CRTs, color tubes are provided that incorporate shadow masks adjacent the screen. For example, in FIG. 1, a portion of a shadow mask 4 is shown. As is typical, the shadow mask 4 is made of a metal sheet with numerous holes, such as the hole 8, permitting three electron beams 2 to pass through and project on the appropriate phosphor areas or spots 6 of a screen, not shown. There typically are three types of phosphor spots, one for each primary color (red, blue and green).

Due to changes in alignment between the center of a beam and a mask's holes, the beam does not produce constant brightness across the screen. For example, FIG. 2a shows a cross section of the shadow mask 4 for the hole 8. In this figure, an electron beam 2 passes through the center of the hole 8. The bell curve 16 shows the cross-sectional profile of the electron intensity distribution of the beam 2, hereafter called the electron beam density. Since the beam 2 passes the center of the hole 8, it produces the maximum light emission from the phosphor (not shown in this figure). Another bell curve 14 shows distribution of the brightness produced at the screen when the beam 2 strikes the phosphor. On the other hand, as seen in FIG. 2b, when the electron beam is 10 obscured by a bridge 12 of the shadow mask 4 between the hole 8 and an adjacent hole 9, far fewer electrons pass, and less light is emitted by the phosphor. This is shown by the bell curve portions 14a. FIG. 3 shows the cross section for a portion of the shadow mask 4. In this figure the electron beam 2 passes through the center of a hole 20, along a center line, and produces a maximum brightness when it strikes the phosphor 6, while the bridge 22 obscures the beam and produces a minimum brightness. The interactions of the size and spacing of shadow mask holes, the electron beam density profile, and the raster interval result in uneven brightness 22 across the screen, which is seen as a pattern of bright and dark stripes. This pattern is called “raster moiré” or, simply, “moiré”. The typical appearance of the moiré pattern is shown in FIG. 4. The moiré pattern degrades the performance of CRT display devices. It is more visible for larger size screens and is highly undesirable.

To eliminate or at least alleviate moiré, a cancellation circuit (referred to as a moiré cancellation circuit hereafter) is typically used. Referring to FIG. 5, a prior art Moiré cancellation circuit is shown. This circuit is explained in detail in Japanese Patent Application H9108792 filed Apr. 25, 1997. In this circuit, a resistor 34 is connected in parallel with a correction capacitor 36. This capacitor improves the horizontal linearity of the raster scanning and provides DC blocking. It is commonly referred to as the S capacitor. A switch 38 toggles at the rate that is one half of the vertical rate, that is, the rate at which the electron beam is returned from the bottom right comer of the CRT screen to the top left corner. When the switch 38 is open, a current flows through the resistor 34. When the switch 38 is closed, an additional current flows through the resistor 34, the switch 38, and the constant voltage source 44. This current shifts the raster position on the screen. A level set signal, usually a voltage level, is applied to the voltage source control input 42. The level set voltage applied to the constant voltage source 44 varies the amount of the DC current, and thus displacement of the raster. The level set applied at input 42 is set, usually at the factory when a product incorporating a CRT is assembled. The level of the setting causes the constant voltage source to produce a voltage on the switch 38 that is appropriate to eliminate or reduce the moiré produced by the scanning mode and the raster interval at which the product operates.

However, it is difficult to apply the circuit of FIG. 5 to television receivers, computer monitors, or any other CRT devices lacking an S capacitor, because it utilizes the voltage difference between the constant voltage source 44 and the junction 33 between the S capacitor 36 and the deflection coil 32. The voltage at this junction is normally set to one half of a supply voltage for the vertical output circuit 28.

In operation, the state of the switch 38 is toggled by the dividing circuit 26 at half the vertical synch rate so that moiré correction occurs during every other scan as required. However, the waveform produced by the moiré correction circuit does not exactly match the waveform of the vertical synch circuit 28, 30, 32, 36. In this regard, the waveform across the S capacitor 36 is the same as that of the vertical deflection current produced on signal path 30 by the vertical output circuit 28. In other words it is an integrated sawtooth waveform, thus making it difficult to produce the identical waveform at the constant voltage source for nullifying.

Furthermore, operating the moiré circuit of FIG. 5 requires an additional switch and two voltage sources; one to control the current and another to disable the Moiré circuit.

In the referenced Japanese Patent Application, moiré cancellation circuit operation shifts the raster scan for every other frame as seen in FIG. 6. The first scan, represented by the set of beam density plots 50, produces a set of light emission profiles 56, producing moiré 22. The second scan, represented by beam density plots 52, is shifted slightly from the first one and produces another set of light emission profiles 54, resulting in moiré 46. Since these two moiré patterns are almost opposite in phase, dark stripes in the first scan superpose bright stripes of the second scan, thereby effectively eliminating or at least reducing the visible moiré pattern 48 for the screen of the CRT display device.

FIG. 7 shows a moiré cancellation circuit applied to a television receiver according to the referenced Japanese Patent Application. This implementation consists of a current mirror 62, an injection current generator 64, a constant current source 56, a current shut off circuit 58, a synch divider circuit 52, and a voltage comparator 54. The moiré cancellation circuit is connected to the vertical section of a beam deflection circuit. The vertical section includes a vertical output circuit 28, a vertical deflection yoke 32, a connection 30 between 28 and 32, and a resistor 66 useful for voltage feedback generation. A control signal, preferably a voltage, applied at control input 42 to the voltage comparator 54 turns on the switch 58 and controls the constant current source 56. Furthermore the vertical synch signal is divided by the synch divider circuit 52, which toggles the current flow in synchronization with the vertical synch rate, that is at one half the rate. This controlled current is injected into the current mirror 62.

The moiré cancellation circuit disclosed in the referenced Japanese Patent Application consists of the current source 64 and the current mirror 62 connected in series to produce a DC current is applied to the vertical section. The constant current source 56 is connected to the junction 63 between the vertical deflection yoke 32 and the resistor 66.

FIG. 8 shows an implementation of the current mirror 62 that includes transistors 76 and 78 and resistors 72 and 74. By the principles of current mirror operation, the collector current of the transistor 76 is equal to that of the transistor 78. Therefore, the current injected to the resistor 66 is determined by the constant current source 56.

FIG. 9 shows another implementation of the current mirror 62 that includes transistors 84 to 90, resistors 80 to 82, a negative power supply 92, and a positive power supply 70. A pair of transistors 84 and 86 and another pair of transistors 88 and 90 form respective current mirrors. By the principles of current mirror operation, the collector currents of the transistors 84 and 88 are equal to the collector currents of the transistors 86 and 90, respectively. Therefore the source current of the transistor 84 is equal to the sink current of transistor 90. Provided that the voltage of the negative voltage supply 92 is low enough, the injected current produced by the constant current source 56 is independent of the supply voltage of the injection current generator.

FIG. 10 shows an implementation of the injection current generator 64 that includes a transistor 104, a resistor 106, a differential amplifier 102, another transistor 112, and resistors 106, 108, and 110. In this circuit, the control voltage 42 may be applied to the non-inverting input of the differential amplifier 102 (used as the current source) and to the transistor 112 through the resistors 108 and 110. The dividing ratio determined by the resistors 108 and 110 sets the threshold of the voltage comparator 54. If the control voltage exceeds the threshold, the transistor 112 turns on and allows current to flow.

Meanwhile, the differential amplifier 102 produces a voltage at the base of the transistor 104 whose value is equal to the voltage applied to the amplifier's non-inverting input. Since the base to emitter voltage of the transistor 104 may be normally 0.7V, the voltage across the resistor 106 may be nearly equal to the control voltage. Thus, collector to emitter current is equal to the value of the control voltage divided by the resistance of the resistor 106, enabling the control voltage to vary the amount of the current flow. Therefore, the DC current flows for every other frame, effectively shifting the raster to produce the effect shown in FIG. 6.

The switch 100 is toggled by a control voltage derived from the vertical synch 24 connected to the non-inverting input of the differential amplifier 102. For each vertical period, the output of the differential amplifier 102 toggles between the level of the control voltage and zero. As shown, the control voltage fed through a single line allows the current flow and controls its amount.

For both of these moiré cancellation circuits, effective control of moiré cancellation is absent. It would be a great convenience and a significant benefit to adaptively control moiré cancellation in response to the particular conditions under which a CRT operates, rather than to depend on a factory setting, which will necessarily be effective only for a single static set of conditions.

### SUMMARY OF THE INVENTION

It is an object of this invention to adaptively control a moiré circuit that eliminates or at least reduces a moiré pattern on the screen of a CRT display device.

In a preferred embodiment, a controller comprising a microprocessor unit, with associated discrimination functions and a memory, in combination with a digital-to-analog convertor adaptively sets one or more conditions for moiré cancellation circuit operations in response to the vertical and horizontal synch signals in a composite signal. Alternatively, the controller may find appropriate condition signals in a formatted composite signal or a component signal.

### BRIEF DESCRIPTION OF THE DRAWING

FIG. 1 shows a portion of a shadow mask used in a cathode ray tube (CRT);

FIGS. 2a and 2b illustrate how the shadow mask of FIG. 1 affects the level of light emitted by a CRT;

FIG. 3 is a partial cross-section of the shadow mask of FIG. 1 showing creation of a moiré pattern;

FIG. 4 shows how the moiré pattern appears on the screen of a CRT;

FIG. 5 is a block/circuit diagram of a prior art moiré cancellation circuit;

FIG. 6 is a cross-section of a shadow mask showing how a moiré cancellation circuit operates to eliminate or attenuate a moiré pattern;

FIG. 7 is a block/circuit diagram of a second prior art moiré cancellation circuit;

FIGS. 8, 9 and 10 are circuit diagrams illustrating various elements of the moiré cancellation circuit of FIG. 6;

FIG. 11 is a block diagram illustrating a moiré cancellation circuit controller according to the invention;

FIG. 12 is a set of waveform plots showing the execution of an interlace/progressive (I/P) scan discrimination function;

FIG. 13 is a waveform diagram illustrating execution of a scan rate (horizontal synch rate) discriminator function;

FIG. 14 is a set of waveform diagrams illustrating execution of a vertical resolution function;

FIG. 15 is a flow diagram illustrating steps of a method according to the invention;

FIG. 16 is a block diagram illustrating an alternate embodiment of a controller for a moiré cancellation circuit according to the invention;

FIG. 17 is a memory diagram illustrating the contents of a memory in FIGS. 11 and 16; and

FIG. 18 is a system diagram of a CRT device incorporating the invention.

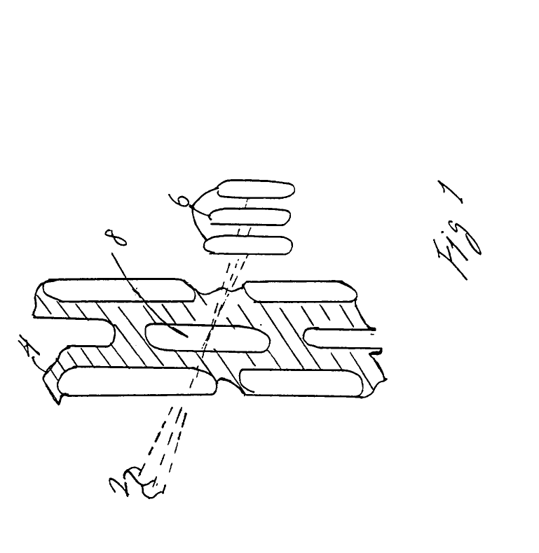

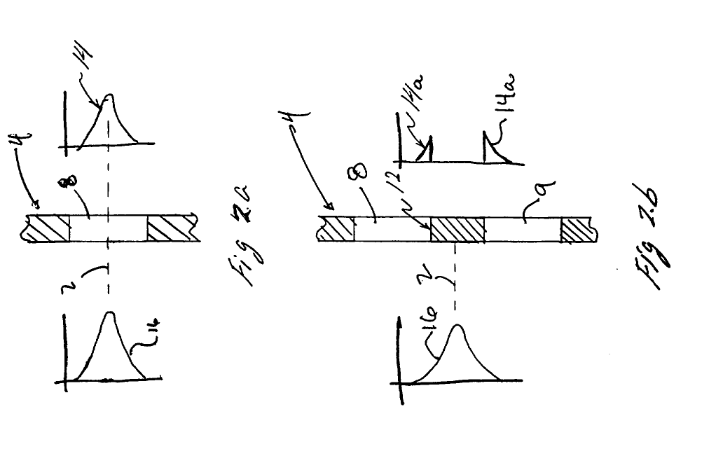

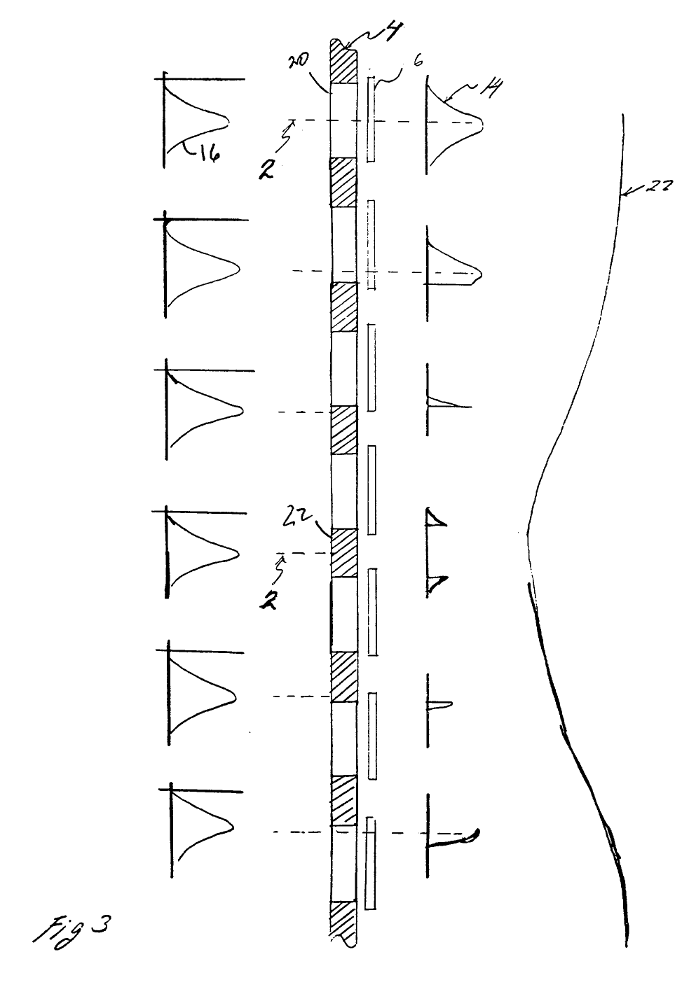

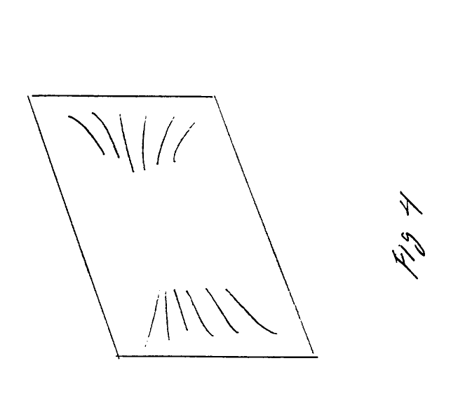

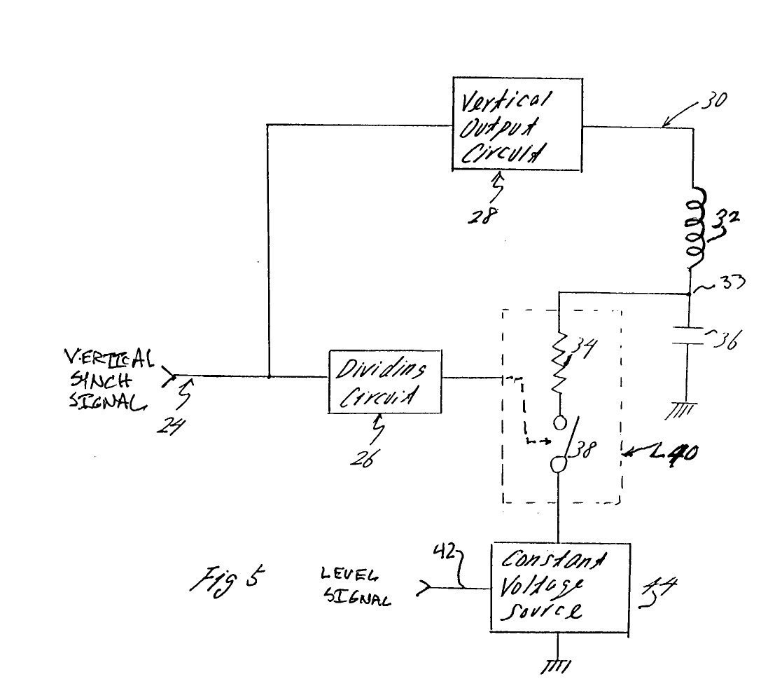

### DETAILED DESCRIPTION OF THE PREFERRED EMBODIMENTS

The invention relates to a circuit and a method to eliminate or at least alleviate the raster moiré caused by interactions of the size and intervals of the holes of a shadow mask, the profile of the electron density for an electron beam, and the interval of the raster in television receivers, computer monitors, and other CRT display devices by controlling the superpositioning of additional DC current on the vertical deflection current for every other frame for progressive scanning or every odd (or even) field for interlaced scanning, resulting in raster shift on the screen. Alternatively, the invention 10 could be utilized to control moiré cancellation in a circuit that depends on the voltage difference between the constant current source and the junction between the S capacitor and the vertical deflection yoke.

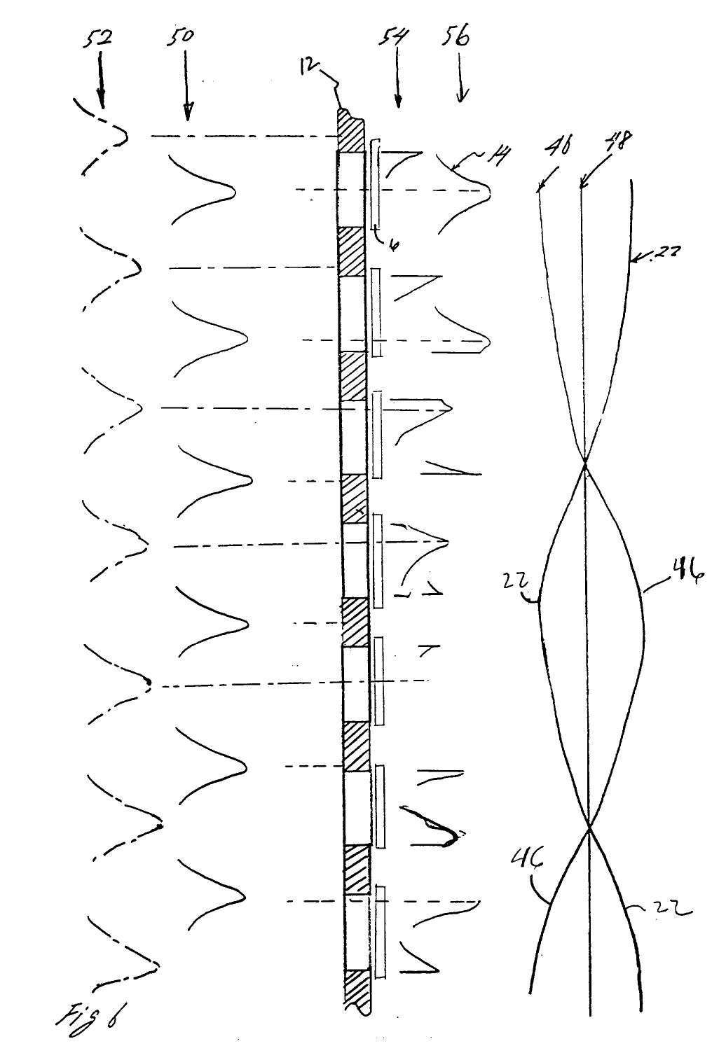

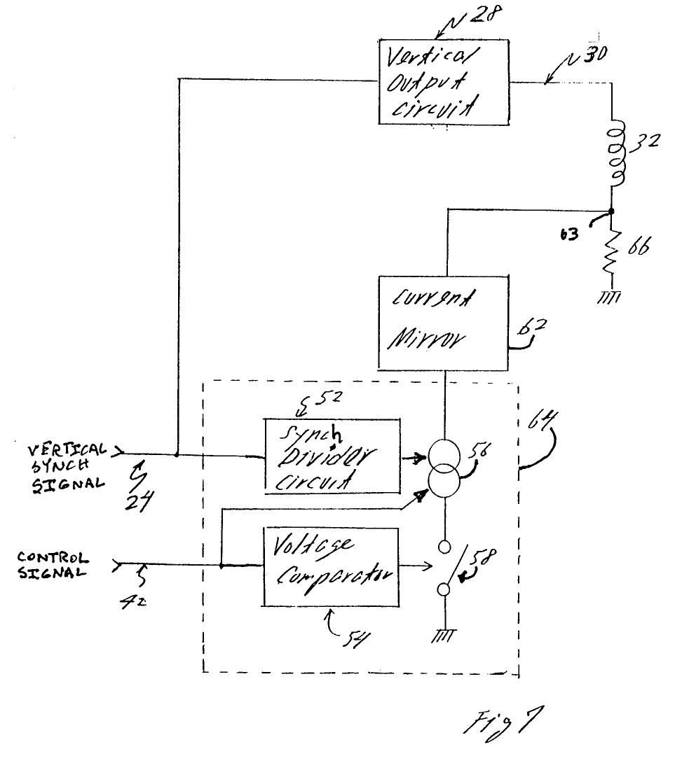

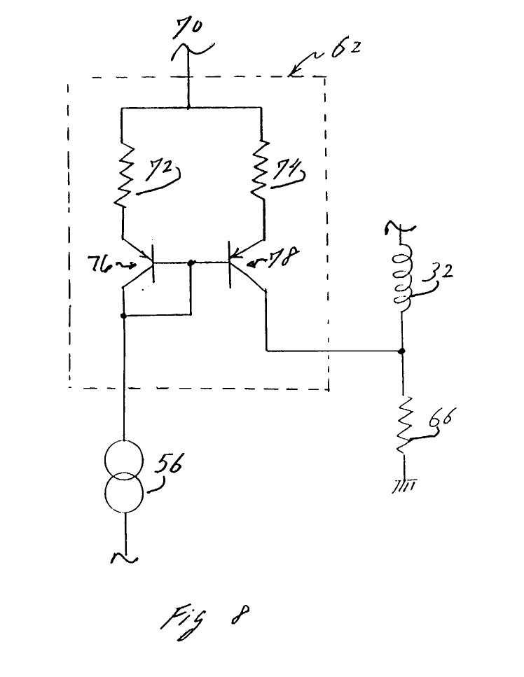

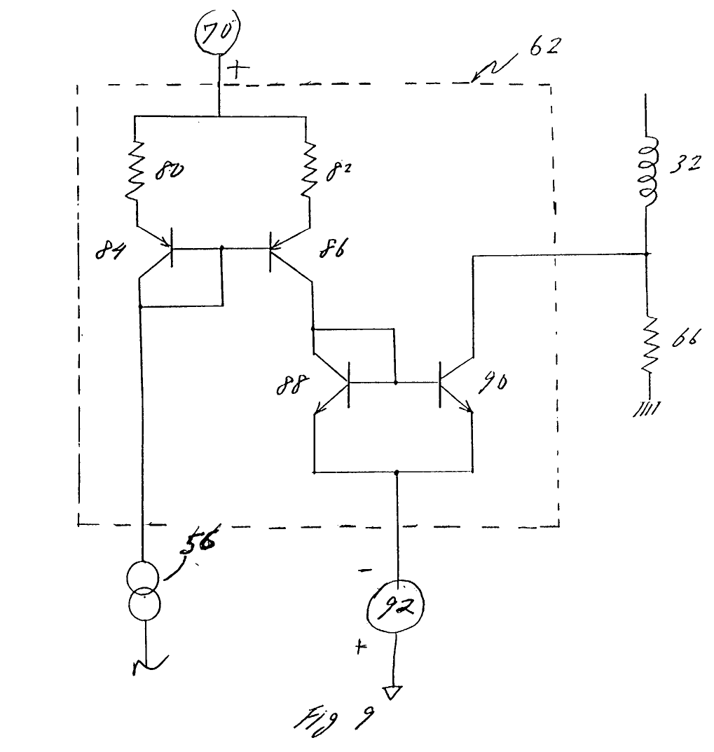

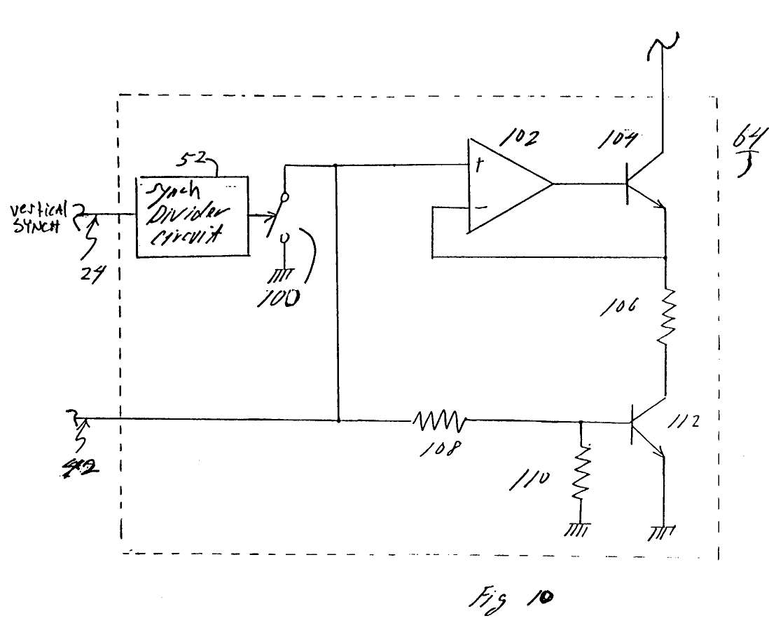

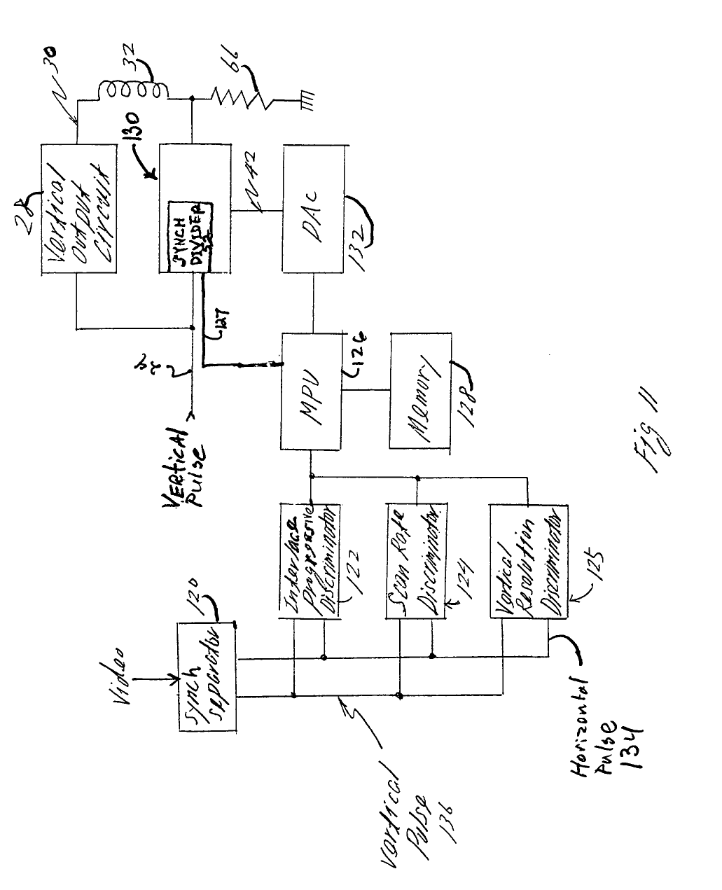

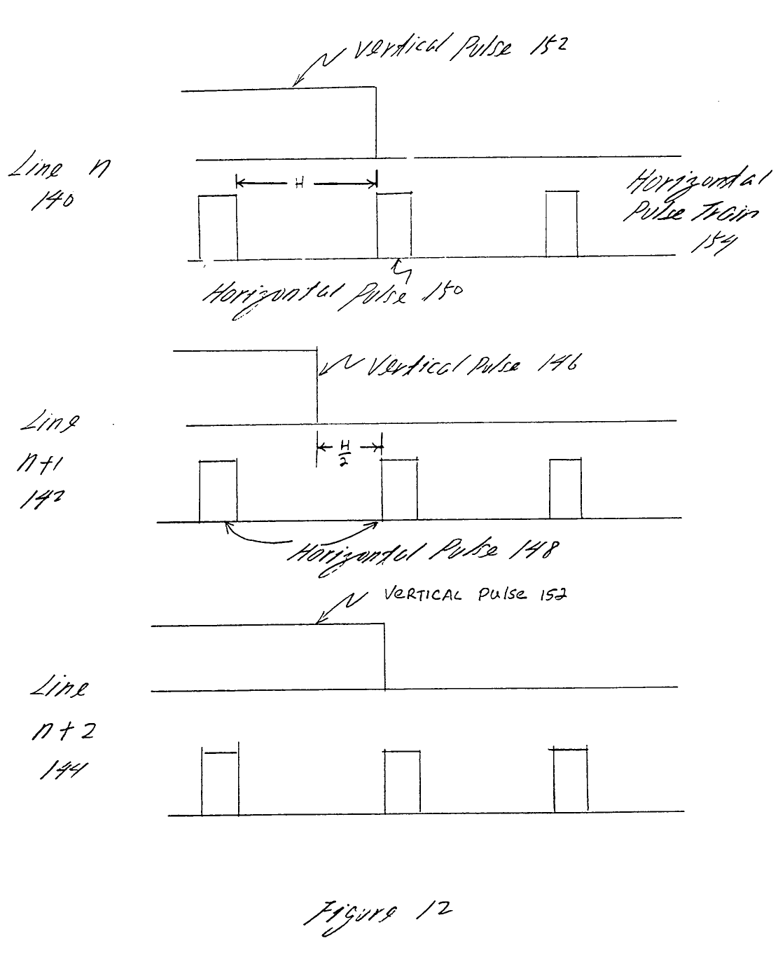

FIG. 11 shows a preferred embodiment of a moiré controller incorporating a microprocessor unit (MPU) 126. The MPU 126 may be a microcomputer or any other type of processing device. A DAC (digital to analog converter) 132, which may or may not reside within the MPU 126, produces the control signal that is applied to a moiré cancellation circuit to control the circuit's operation in eliminating or attenuating moiré. For example, in the moiré cancellation circuit of FIGS. 5 and 7, the control signal would be applied at control input 42 according to instructions from the MPU. A synch separator 120 receives the incoming video signal and extracts horizontal synch pulses and vertical synch pulses, placing them on signal paths 134 and 136, respectively. An interlace/progressive discriminator function 122 may use the phase relation of these two signals to determine whether the incoming signal has a progressive or interlace scan. For example, with reference to FIG. 12, if all vertical pulses for each scan are coincident with horizontal pulses, the function determines that the incoming video signal is a progressive type scan. However, if, as in FIG. 12, a vertical synch pulse 146: 1) falls between two horizontal synch pulses 148 for every other line (i.e. skipping successive scans), and 2) is coincident with the horizontal synch pulse 150 for the previous line 140, the MPU 126 determines that the incoming signal is an interlace type scan. For interlaced scanning, the MPU provides a signal on signal path 127 that causes the synch divider 52 to pass the vertical synch pulse for either of the even or odd fields. For progressive scanning, the MPU provides a signal on signal path 127 that causes the synch divider 52 to pass every other vertical synch pulse.

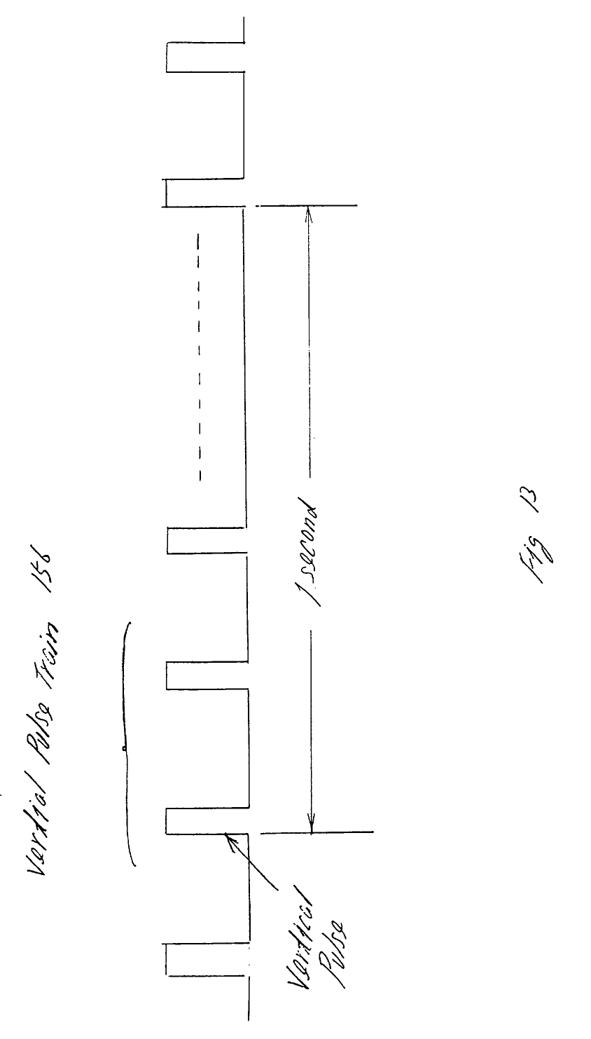

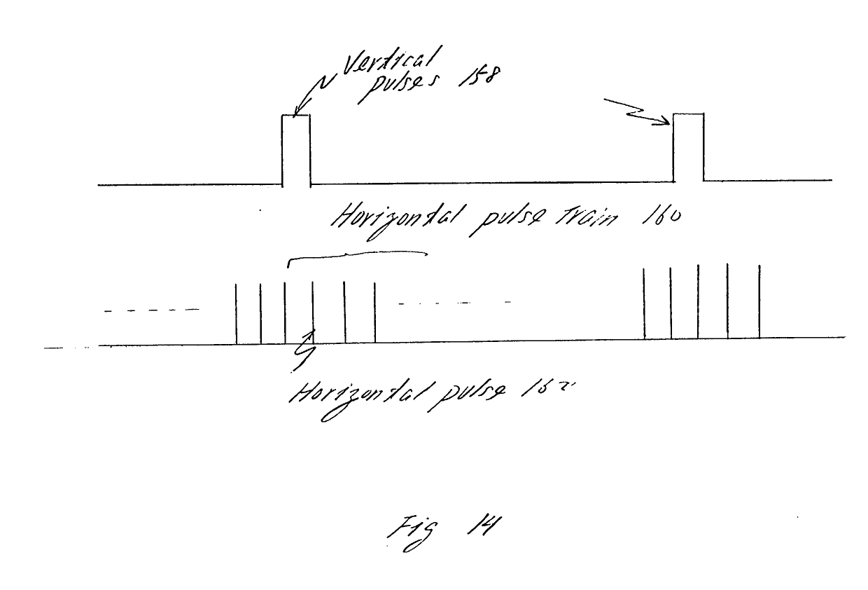

As represented in FIG. 13, the frame rate discriminator function 124 may be accomplished by counting numbers of vertical pulses 156 for one second, that number being approximately equal to the frame rate. An alternate method for frame rate determination may be accomplished simply by measuring the time between two successive vertical pulses and mathematically inverting its value. As represented in FIG. 14, the vertical resolution discrimination function 125 (shown in FIG. 11) may be executed by counting numbers of horizontal pulses 160 between two vertical pulses 158. This results in the vertical resolution of the incoming video signal.

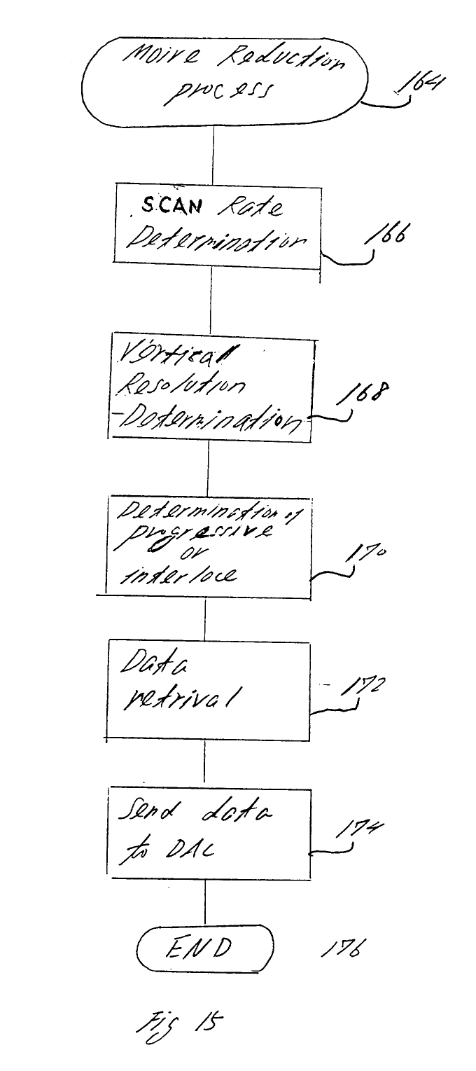

FIG. 15 shows a flow diagram of a software program, routine or algorithm running in the microprocessor that may be executed to implement the moiré control function. Step 164 is the entry point of the procedure. Next step 166 determines the vertical frame rate of the video signal. The vertical resolution of the video signal is determined in step 168. The type of scan (interlaced or progressive) is determined in step 170. It should be noted that these four steps may be performed in any order. As shown in FIG. 11, data representing the decision of the interlace-progressive (I/P) discrimination element 122, the calculated value from scan rate discrimination element 124, and the vertical synch rate from the vertical resolution discrimination element 125 are provided to the MPU 126. The MPU 126 retrieves the corresponding data in step 172, and sends it to the DAC 132 of FIG. 11. The DAC produces a control voltage that is provided to the moiré cancellation circuit 130 by way of the control line 42.

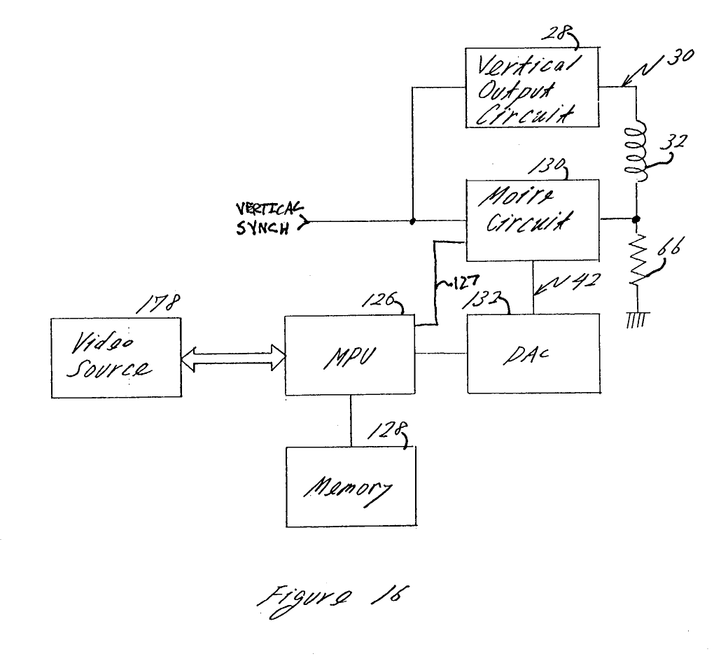

An alternate embodiment of the moiré circuit controller is shown in FIG. 16, which illustrates an embodiment where discrete discrimination elements 122, 124, and 125 are not necessary. This less complex and lower cost embodiment relies on an external video source 178 sending the I/P data, scan rate data, and vertical synch rate data of the given video signal, directly to the TV or display monitor. This data may be sent via separate control data lines or mixed with the video signal. Such data lines may be combined in a single cable and connector, or embodied in separate cables and connectors. The video source 178 may be an analog or digital television set top box (TV receiver, decoder, etc.), video camera, computer system with video out, or magnetic/optical video storage device. The set top box could be used for terrestrial broadcast, cable TV or satellite video applications. As shown in FIG. 16, the I/P, scan rate, and vertical resolution data could be sent in parallel or serial manner directly to the TV's MPU 126. According to the information received, the MPU may send the data to the DAC 132 to generate a correction voltage to eliminate or at least improve (lessen) the moiré pattern visible to the viewer.

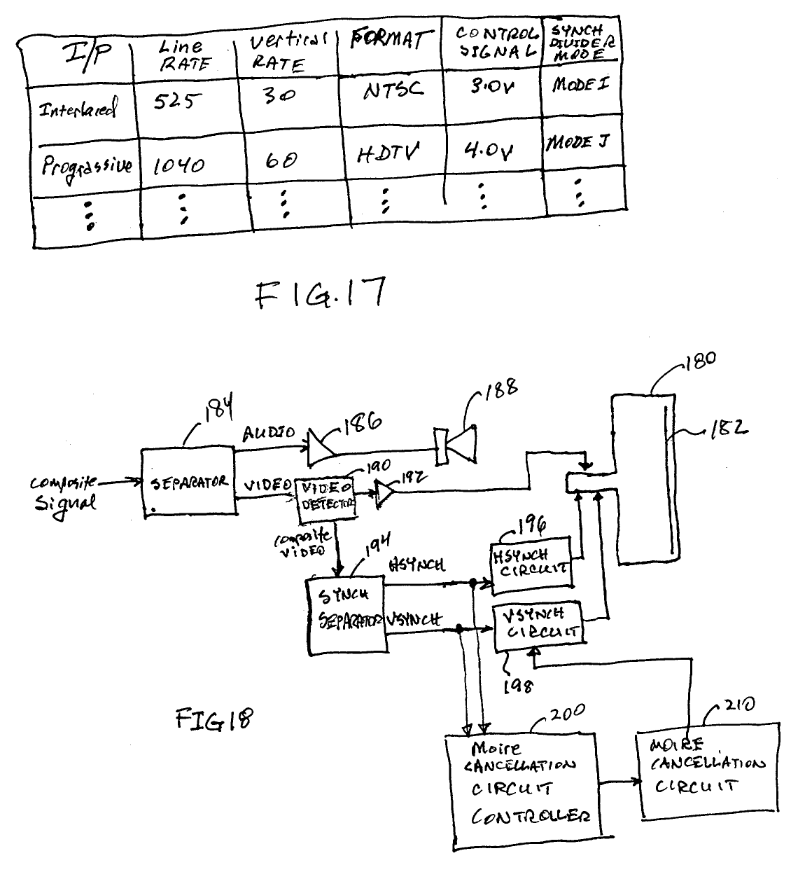

FIG. 17 illustrates a representative layout of the memory 128 of either or both embodiments of the invention illustrated in FIGS. 11 and 16. In this regard, a table represents one possible data structure for relating a particular kind of CRT scan format, such as NTSC or HDTV, to the control signal or signals provided to set the level of operation for any of the moiré cancellation circuits discussed above or their equivalents. Conventionally, any standard format can be determined by a respective combination of scan mode (I/P), line rate and vertical rate. Thus, the NTSC format is precisely identified by interlaced scanning, 525 lines per field, a vertical synch rate of 30 per second. As an example, the control signal provided to the moiré cancellation circuit, illustrated in FIG. 7 and discussed above, by the DAC on control line 42 might be 3.0 volts. Further, the memory structure could include the preferred mode of operation of the synch divider 52.

In operation, the MPU 126 would look up a value for the control signal for the DAC 132 appropriate to produce a predetermined voltage for the format indicated, as well as the mode of operation for the synch divider 52. These two signals would be provided to the DAC 132 and to the synch divider 52 as discussed above. The MPU 126 would be enabled to index into the table of FIG. 17 either by a combination of values for I/P line rate, and vertical rate, as determined by functions that may be external or integral to the MPU 126. Alternately, in the manner of FIG. 16, the formatted signal from the video source 178 could provide the index into the table by identifying the format or by providing the three relevant values. The inventor also contemplates that the formatted signal from the video source 178 could simply provide the values in the control signal and synch divider mode columns of the table.

FIG. 18 illustrates a CRT device as an example of a system in which the moiré cancellation circuit controller of this invention could be implemented. In this regard, a CRT 180 including a screen mask 182 has its scanning operations controlled by a beam deflection circuit having a horizontal portion, a vertical synch portion and a video portion. In this regard, the product receives a composite signal that is separated at 184 into audio and video components, with the audio components being amplified at 186 and output at 188. The video component is provided to a video detector 190 which extracts a video signal providing it to a video amplifier circuit 192 that appropriately controls the sources of one or more electron beams in the CRT 180. The video detector 190 also provides a composite video signal to a synch separator 194 that extracts a horizontal synch signal (HSYNCH) coupled to a horizontal synch circuit 196 that controls scanning of the electron beams of the CRT 180. The synch separator 194 also provides a vertical synch signal (VSYNCH) to a vertical synch circuit 198 that control a vertical synchronization of the electron beams in the CRT 180. A moiré cancellation circuit controller 200, according to either of FIG. 11 or 16, or any equivalent of either of these embodiments, receives both horizontal and vertical synchronization signals as discussed above, either from the synch separator 194 or, as per FIG. 16, from the composite video signal itself or some equivalent thereof. The controller 200 provides the control signals to a moiré cancellation circuit 210 that may be built and operated according to FIG. 5 or 7 or any equivalents thereof.

The above are just some of the possible embodiments of the invention described herein. Other embodiments or improvements will be obvious to those skilled in the art.

I claim:

1. A display device comprising:
a display element;
a beam deflection circuit coupled to the display element;
a moiré cancellation circuit connected to the beam deflection circuit; and
a controller connected to the moiré cancellation circuit for setting an operational condition of the moiré cancallation circuit.
